(19) United States
(12) Patent Application Publication
(10) Pub. No.: US 2025/0373195 A1
(43) Pub. Date: Dec. 4, 2025

(54) SOLAR MODULE FRAME COUPLING ASSEMBLIES

(71) Applicant: Nextracker LLC, Fremont, CA (US)

(72) Inventors: Alexander W. AU, Oakland, CA (US); Craig Bradley Edward Wildman, Kensington, CA (US); Ricardo Delgado-Nanez, San Jose, CA (US); Ryan Patel, Pleasanton, CA (US); Madeleine Davis Kho, Oakland, CA (US)

(21) Appl. No.: 19/214,560

(22) Filed: May 21, 2025

Related U.S. Application Data
(60) Provisional application No. 63/654,349, filed on May 31, 2024.

(51) Int. Cl. H02S 20/32; H02S 20/10

(52) U.S. Cl. CPC H02S 20/32; H02S 20/10

(57) ABSTRACT

A method for coupling a solar module frame to a torque tube of a solar tracker using a hooked flange solar module frame coupling apparatus includes: positioning a hook portion the of frame component relative to a frame receiving receptacle at a rail; moving the hook portion of the frame from a biased, coupling configuration to a receptacle entry configuration via contact between the hook portion and the rail; and moving the hook portion from the receptacle entry configuration to the biased, coupling configuration to couple the frame to the rail.

### RELATED APPLICATION

This disclosure claims priority to U.S. Provisional Patent Application No. 63/654,349, filed May 31, 2024, the content of which is hereby incorporated by reference.

### TECHNICAL FIELD

This disclosure relates generally to device, system, and method embodiments of solar module frames and to coupling one or more solar module frames to a support structure. Solar module frames and related coupling device, system, and method embodiments disclosed herein can be configured to facilitate more efficient and effective installation of one or more solar modules to a support structure, such as a torque tube of a solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application.

### SUMMARY

This disclosure in general describes device, system, and method embodiments relating to solar module frames and solar module frame coupling apparatuses for coupling one or more solar module frames to a support structure. Such device, system, and method embodiments disclosed herein can be configured to facilitate more efficient and effective coupling installation of one or more solar module frames to a support structure. For example, solar module frames and/or coupling apparatus embodiments disclosed herein can be configured to facilitate more efficient and effective installation of one or more solar module frames to a torque tube of a solar tracker (e.g., a single-axis solar tracker). In some such examples, solar module frame coupling device, system, and method embodiments disclosed herein can be configured to facilitate automated (e.g., autonomous, such as fully or partially robotic) installation of one or more solar modules to a torque tube using one or more solar module frame coupling apparatus embodiments disclosed herein. In additional or alternative such examples, solar module frame coupling device, system, and method embodiments disclosed herein can be configured to reduce a number of connection points needed between components to effectively couple a solar module frame to a torque tube and, thereby, can help to reduce costs associated with solar tracker installation.

One embodiment includes a method for coupling a solar module frame to a torque tube of a solar tracker using a hooked flange solar module frame coupling apparatus. This method embodiment includes: positioning a hook portion of frame component relative to a frame receiving receptacle at a rail; moving the hook portion of the frame from a biased, coupling configuration to a receptacle entry configuration via contact between the hook portion and the rail; and moving the hook portion from the receptacle entry configuration to the biased, coupling configuration to couple the frame to the rail.

Another embodiment includes a method for coupling a solar module to a torque tube of a solar tracker using a rotational frame solar module frame coupling apparatus. This method embodiment includes: positioning a rail coupling flange of a frame relative to a rail; after so positioning the rail coupling flange, moving the rail coupling flange from a stowed configuration to an installation configuration; and coupling the rail coupling flange in the installation configuration to the rail.

An additional embodiment includes a method for coupling a solar module to a torque tube of a solar tracker using a frame rotational arm solar module frame coupling apparatus. This method embodiment includes: moving at least one frame rotational arm component from a stowed configuration to an installation configuration; positioning the frame rotational arm component, in the installation configuration, relative to torque tube; and placing a fastener at the frame rotational arm component, in the installation configuration, to couple the frame to the torque tube.

Another embodiment includes a method for coupling a solar module to a torque tube of a solar tracker using a slide track solar module frame coupling apparatus. This method embodiment includes aligning an open end of a track cutout at a solar module frame with a protruded connection member of a rail; vertically moving the solar module frame to move the protruded connection member at the rail into the connection member receptacle at the track cutout at the frame; laterally moving the solar module frame to engage the protruded connection member of the rail at the connection member receptacle of the frame; and fastening a frame sidewall to a rail sidewall when the protruded connection member of the rail is engaged at the connection member receptacle of the frame.

An additional embodiment includes a method for coupling a solar module to a torque tube of a solar tracker using a multi-strap rail solar module frame coupling apparatus. This method embodiment includes: positioning a frame body relative to a torque tube such that a first strap, in an installation position, of a first pair of straps at a first side of the frame body is adjacent to a first side of the torque tube and a second strap, in an installation configuration, of the first pair of straps at the first side of the frame body is adjacent to a second, opposite side of the torque tube; deforming the first strap of the first pair of straps from the installation configuration to wrap around at least a portion of the torque tube from the first side of the torque tube; deforming the second strap of the first pair of straps from the installation configuration to wrap around at least a portion of the torque tube from the second side of the torque tube and with at least a portion of the first and second straps overlapping along at least a portion of a perimeter around the torque tube; and, after deforming the first and second straps, fastening together the first and second straps around the torque tube.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a schematic, perspective view of a solar tracker apparatus.

FIGS. 2A-2J illustrate one embodiment of a hooked flange solar module frame coupling apparatus. FIG. 2A is a perspective view and FIG. 2B is a side elevational view of the hooked flange solar module frame coupling apparatus coupling solar modules to a torque tube of a solar tracker. FIGS. 2C and 2D are, respectively, side elevational and perspective views of a rail component of the hooked flange solar module frame coupling apparatus. FIGS. 2E and 2F are, respectively, first and second side elevational views of a frame component of the hooked flange solar module frame coupling apparatus, with the second side elevational view at FIG. 2F being ninety degrees offset from the first side. FIGS. 2G-2I illustrate an embodiment of a sequence for coupling the frame component, of FIGS. 2E and 2F, to the rail component, of FIGS. 2C and 2D. FIG. 2J is a flow diagram of an embodiment of a method for coupling a solar module to a torque tube of a solar tracker using the hooked flange solar module frame coupling apparatus.

FIGS. 3A-3C illustrate another embodiment of a hooked flange solar module frame coupling apparatus. The hooked flange solar module frame coupling apparatus of FIGS. 3A-3C can be similar to, or the same as, the hooked flange solar module frame coupling apparatus of FIGS. 2A-2J except that the orientation of the hook member of the frame component can have an inverse configuration as the hook member of the frame component of the hooked flange solar module frame coupling apparatus of FIGS. 2A-2J. FIG. 3A is a side elevational view of this embodiment of the hooked flange solar module frame coupling apparatus, FIG. 3B is a side elevational view of the a rail component of this embodiment of the hooked flange solar module frame coupling apparatus, and FIG. 3C is a side elevational view of two stacked frame components of this embodiment of the hooked flange solar module frame coupling apparatus.

FIGS. 4A-4F illustrate an embodiment of a rotational frame solar module frame coupling apparatus. FIG. 4A is a perspective view and FIG. 4B is a side elevational view of the rotational frame solar module frame coupling apparatus coupling solar modules to a torque tube of a solar tracker. FIGS. 4C-4E illustrate an embodiment of a sequence for rotating a frame component from a stowed configuration to an installation configuration at which the frame component can be coupled to a rail component of the rotational frame solar module frame coupling apparatus. FIG. 4F is a flow diagram of an embodiment of a method for coupling a solar module to a torque tube of a solar tracker using the rotational frame solar module frame coupling apparatus.

FIGS. 5A-5E illustrate an embodiment of a frame rotational arm solar module frame coupling apparatus. FIG. 5A is a perspective view and FIG. 5B is a side elevational view of the frame rotational arm solar module frame coupling apparatus coupling solar modules to a torque tube of a solar tracker. FIG. 5C is a side elevational view of the of a frame rotational arm component, of a frame of the frame rotational arm solar module frame coupling apparatus, in a stowed configuration, and FIG. 5D a side elevational view of the of the frame rotational arm component in an installation configuration. FIG. 5E is a flow diagram of an embodiment of a method for coupling a solar module to a torque tube of a solar tracker using the frame rotational arm solar module frame coupling apparatus.

FIGS. 6A-6E illustrate an embodiment of a vertical solar module frame coupling apparatus. FIG. 6A is a perspective view and FIG. 6B is a side elevational view of the vertical solar module frame coupling apparatus. FIG. 6C is a perspective view of a rail component of the vertical solar module frame coupling apparatus. FIG. 6D is a side elevational view and FIG. 6E is a perspective view of a frame component of the vertical solar module frame coupling apparatus.

FIGS. 7A-7E illustrate an embodiment of a vertical rail tab solar module frame coupling apparatus. For example, the vertical rail tab solar module frame coupling apparatus can be similar in installation to the vertical solar module frame coupling apparatus of FIGS. 6A-6E. FIG. 7A is a perspective view and FIG. 7B is a side elevational view of the vertical rail tab solar module frame coupling apparatus. FIG. 7C is a perspective view of a rail component of the vertical rail tab solar module frame coupling apparatus. FIG. 7D is a side elevational view and FIG. 7E is a perspective view of a frame component of the vertical rail tab solar module frame coupling apparatus.

FIGS. 8A-8D illustrate an embodiment of a standoff rail solar module frame coupling apparatus. FIG. 8A is a perspective view of the standoff rail solar module frame coupling apparatus coupling solar modules to a torque tube of a solar tracker. FIG. 8B shows a closeup, detailed perspective view of FIG. 8A to show a standoff component installed at the torque tube. FIG. 8C shows a perspective view of the standoff rail of the standoff rail solar module frame coupling apparatus. FIG. 8D shows a perspective view of a portion of a standoff receiving channel at a solar module component of the standoff rail solar module frame coupling apparatus.

FIGS. 9A-9F illustrate an embodiment of a slide track solar module frame coupling apparatus. FIG. 9A is a perspective view and FIG. 9B is a side elevational view of the slide track solar module frame coupling apparatus coupling solar modules to a torque tube of a solar tracker. FIGS. 9C is a perspective view and FIG. 9D is a side elevational view of a rail component of the slide track solar module frame coupling apparatus. FIG. 9E is a perspective view of a frame component of the slide track solar module frame coupling apparatus. FIG. 9F is a flow diagram of an embodiment of a method for coupling a solar module to a torque tube of a solar tracker using the slide track solar module frame coupling apparatus.

FIGS. 10A-10E illustrate an embodiment of a multi-strap rail solar module frame coupling apparatus. FIG. 10A is a perspective view of a torque tube with rail components of the solar module frame coupling apparatus installed at the torque tube. FIG. 10B is a perspective view and FIG. 10C is a side elevational view of a multi-strap solar module component in an installation configuration. FIG. 10D is a perspective view of the multi-strap solar module component in a coupling configuration where the straps at the multi-strap solar module component are deformed relative to the installation configuration to couple the multi-strap solar module component to the torque tube. FIG. 10E is a flow diagram of an embodiment of a method for coupling a solar module to a torque tube of a solar tracker using the multi-strap rail solar module frame coupling apparatus.

### DETAILED DESCRIPTION

The following detailed description is exemplary in nature. The following description provides some practical illustrations for implementing examples of the present invention. Those skilled in the art will recognize that many of the noted examples have a variety of suitable alternatives.

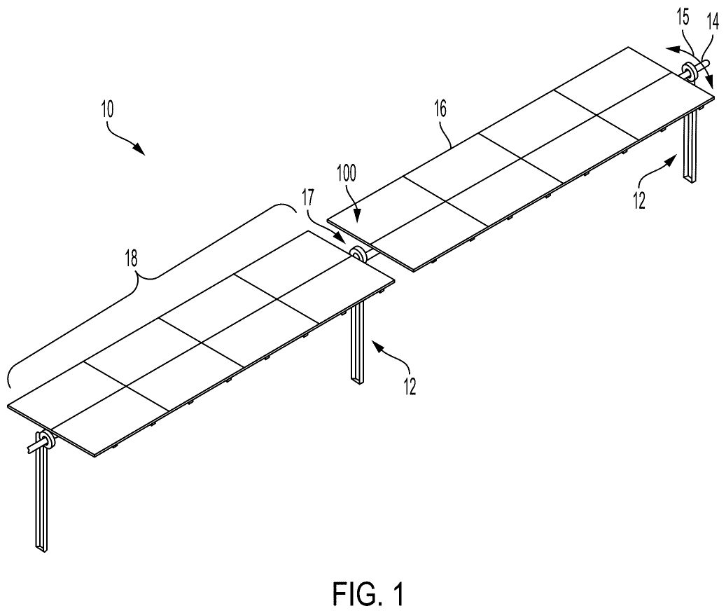

FIG. 1 illustrates an embodiment of a solar tracker apparatus 10. The solar tracker apparatus 10 can include a plurality of piers 12 disposed in spaced relation to one another and embedded in the ground. The solar tracker apparatus 10 can include one or more torque tubes 14 that can extend between adjacent piers 12 and can be rotatably supported at each pier 12. The solar tracker apparatus 10 can further include a plurality of solar modules 16 (e.g., solar panels having photovoltaic cells, such as a photovoltaic laminate with a plurality of photovoltaic cells) supported at the torque tube 14. The one or more torque tubes 14 can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 can be referred to as a bay 18 and, for example, in certain applications may be generally in the range of about 8 meters in length and each bay 18 can be rotatably connected to an adjacent bay 18 via the bearing housing assembly 17. A plurality of solar tracker apparatus 10 rows may be arranged in a north-south longitudinal orientation to form a solar array.

Each solar module 16 can include a solar module frame 100 that is coupled to the torque tube 14. As will be described herein, in some instances, the solar module frame 100 can be directly coupled to the torque tube 14 and in other instances the solar module frame 100 can be indirectly coupled to the torque tube 14 by coupling the solar module frame 100 directly to a rail component and coupling that rail to the torque tube 14. As will also be described herein, in various embodiments, adjacent pairs solar module frames 100 of adjacent pairs of solar modules 16 can be coupled together to the torque tube 14 (e.g., indirectly using a common rail component). The following disclosure will describe various solar module frame coupling apparatus embodiments that can be used, for instance, in a solar tracker to couple one or more (e.g., a pair of) solar modules to a torque tube of a solar tracker. Such embodiments disclosed herein can be useful in facilitating more labor-efficient solar module frame installation at a solar tracker apparatus and/or reduced material costs by reducing frame material associated with coupling to the torque tube. For instance, embodiments disclosed herein can reduce a number of connection points, such as between a solar module frame and a rail, between a solar module frame and a torque tube, and/or between a rail and a torque tube. These embodiments can thus be useful in increasing the cost efficiency associated with installing a solar tracker system in the field. For example, such embodiments disclosed herein can provide structures at solar module frame components and/or rail components that are conducive to robotic installation along a robotic work axis while also reducing a number of connection points.

Thus, solar module frame coupling apparatuses, and the components thereof, can be configured to facilitate more efficient and effective coupling installation of one or more solar module frames to a support structure. For example, solar module frame coupling apparatus embodiments disclosed herein can be configured to facilitate more efficient and effective installation of one or more solar module frames to a torque tube, such as in solar tracker applications, for instance, such as that shown at the example of FIG. 1. These solar module frame coupling apparatus embodiments will be discussed as follows in conjunction with the accompanying drawing figures. The illustrated embodiments are examples of the inventive concepts disclosed herein and as such it should be noted that features of various illustrated solar module frame coupling apparatus embodiments can be intermixed and combined for certain applications within the scope of this disclosure.

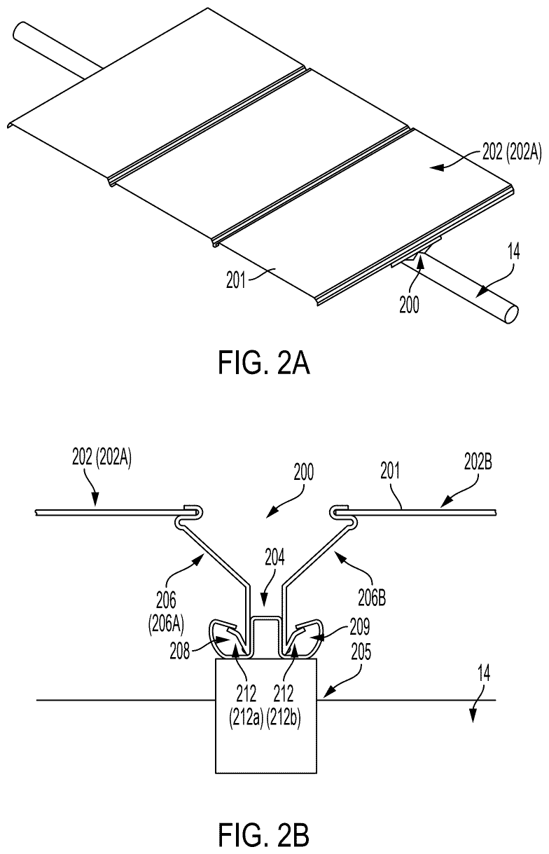

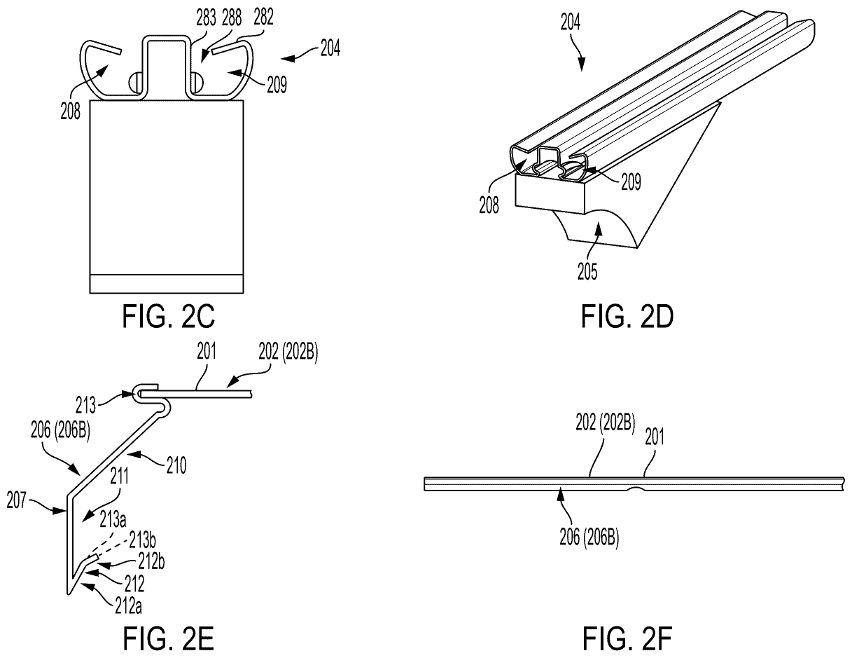

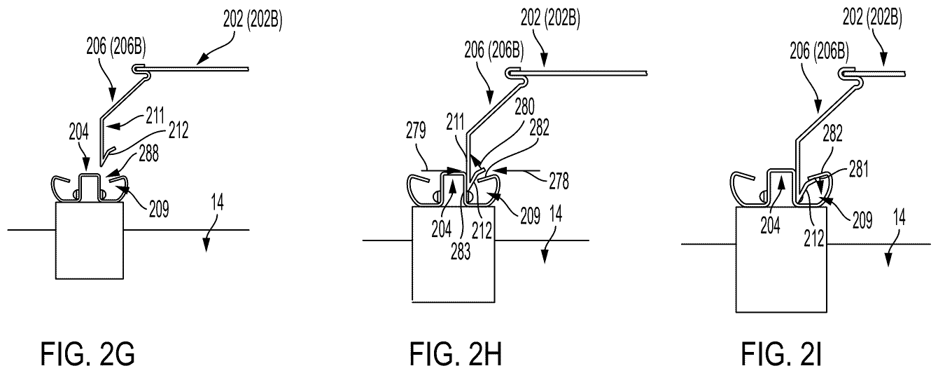

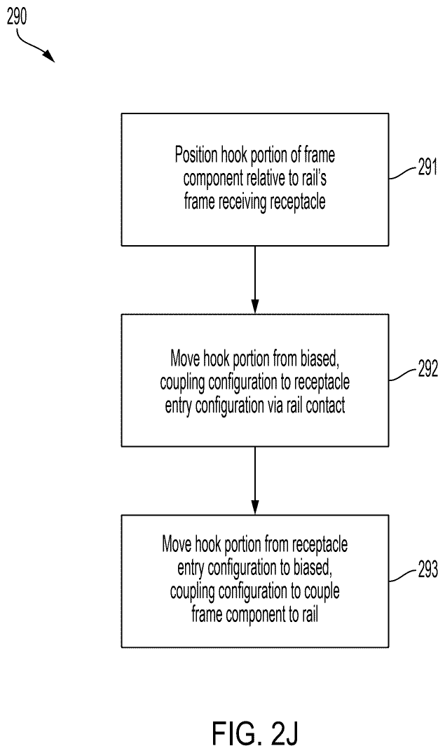

FIGS. 2A-2J illustrate one embodiment of a hooked flange solar module frame coupling apparatus 200. FIG. 2A is a perspective view and FIG. 2B is a side elevational view of the hooked flange solar module frame coupling apparatus 200 coupling solar modules 202 to torque tube 14 of a solar tracker. FIGS. 2C and 2D are, respectively, side elevational and perspective views of a rail component 204 of the hooked flange solar module frame coupling apparatus 200. FIGS. 2E and 2F are, respectively, first and second side elevational views of a solar module frame component 206 of the hooked flange solar module frame coupling apparatus 200, with the second side elevational view at FIG. 2F being ninety degrees offset from the first side. FIGS. 2G-2I illustrate an embodiment of a sequence for coupling the frame component 206, of FIGS. 2E and 2F, to the rail component 204, of FIGS. 2C and 2D. FIG. 2J is a flow diagram of an embodiment of a method 290 for coupling a solar module 202 to a torque tube 14 of a solar tracker using the hooked flange solar module frame coupling apparatus 200.

The hooked flange solar module frame coupling apparatus 200 can include at least one solar module 202 and at least one rail component 204. The solar module 202 can include solar module frame component 206 and a plurality of photovoltaic cells 201 (e.g., a PV laminate 201) supported at (e.g., bounded by) the solar module frame component 206. The rail 204 can be configured to interface with torque tube 14, and the rail 204 can be configured to receive thereat one or more solar modules 202 to couple such one or more solar modules 202 to the torque tube 14 via the rail 204. To interface with a generally circular cross-sectional shaped torque tube 14, rail 204 can include a torque tube interfacing cutout 205 (see, e.g., FIG. 2D) in the form of a semi-circular recess at which the rail 204 is configured to contact and sit at the torque tube 14 or other interfacing component.

The illustrated embodiment of the solar module frame component 206, for instance as shown at FIGS. 2E and 2F, can form a perimeter of the solar module 202, and the solar module frame component 206 can be configured to couple to the rail 204. As shows for the illustrated example, the solar module frame component 206 can define a rail coupling flange 207 at the solar module frame component 206. The rail coupling flange 207 can include an angled upper section 210, a vertical lower section 211, and a hook portion 212. The angled upper section 210 can define a photovoltaic receptacle 213 that is configured to receive and hold a photovoltaic substrate 201 (e.g., a PV laminate). The angled upper section 210 can extend at a non-zero angle relative to the vertical lower section 211, such as at a skewed angle ranging from ten to eighty degrees, such as from thirty five to fifty five degrees relative to the vertical lower section 211. The skewed angular orientation of the angled upper section 210 can help to increase packing density for shipping and can allow for use of smaller profile rail component. The vertical lower section 211 can extend generally vertically from the angled upper section 210 and can bridge between the angled upper section 210 and the hook portion 212. The hook portion 212 can extend out radially from the vertical lower section 211. The illustrated embodiment here shows the hook portion 212 extending radially out from the vertical lower section 211 in a same direction at which the angled upper section 210 extends at the non-zero angle relative to the vertical lower section 211 (e.g., hook portion 212 can extend out radially from the vertical lower section 211 in a same direction that the PV substrate 201 extends out from the angled upper section 210). The hook portion 212 can include a first hook portion 212a and a second hook portion 212b and, in some examples such as that shown here, the first hook portion 212a can extend out radially from the vertical lower section 211 along a first axis 213a and the second hook portion 212b can extend out radially from the first hook portion 212a along a second axis 213b that is different than the first axis. The hook portion 212 can be configured to engage the rail 204, for instance in some examples without the use of an additional fastening component between the hook portion 212 and the rail 204.

The illustrated embodiment of the rail 204 of the hooked flange solar module frame coupling apparatus 200 is configured to receive a pair of solar modules 202A, 202B and couple such pair of solar modules 202A, 202B to torque tube 14. To do so, rail 204 can be configured to receive first solar module frame component 206A of solar module 202A and second solar module frame component 206B of solar module 202B. Rail 204 can include a first frame receiving receptacle 208 that is configured to receive a portion of first solar module frame component 206A and a second frame receiving receptacle 209 that is configured to receive a portion of second solar module frame component 206B. As shown for example at FIG. 2B the first frame receiving receptacle 208 can be configured to receive hook potion 212 (212a) of first solar module frame component 206A and the second frame receiving receptacle 209 can be configured to receive hook potion 212 (212b) of second solar module frame component 206B. The rail 204 can be configured to couple a first side of first solar module frame component 206A to torque tube 14 (e.g., without needing an additional fastening component, such as a bolt, screw, or rivet) by receiving hook portion 212a of first solar module frame component 206A at first frame receiving receptacle 208 and to also couple a second, interfacing side of second solar module frame component 206B to torque tube 14 (e.g., without needing an additional fastening component, such as a bolt, screw, or rivet) by receiving hook portion 212b of second solar module frame component 206B at second frame receiving receptacle 209.

FIGS. 2G-2I illustrate an embodiment of a sequence for coupling one frame component 206 (e.g., second solar module frame component 206B) to rail 204, and FIG. 2J illustrates a flow diagram of an embodiment of a method 290 for coupling solar module 202 (e.g., second solar module 202B) to torque tube 14 using the hooked flange solar module frame coupling apparatus 200. These drawings figures will be discussed in conjunction as follows.

At step 291, the method 290 includes positioning hook portion 212 of frame component 206 relative to frame receiving receptacle 209 at rail 204. FIG. 2G illustrates one example of such positioning of hook portion 212 of frame component 206 relative to frame receiving receptacle 209 at rail 204. In particular, as FIG. 2G shows, the hook portion 212 can be positioned relative to the frame receiving receptacle 209 at rail 204 by aligning a distal end portion of the hook portion along an insertion axis with an opening 288 between adjacent walls at rail 204 that define through the opening the frame receiving receptacle 209.

At step 292, the method 290 includes moving the hook portion 212 of the frame component 206 from a biased, coupling configuration to a receptacle entry configuration via contact between the hook portion 212 and the rail 204. FIG. 2G shows one example of the biased, coupling configuration of the hook portion 212. The hook portion 212 can be biased to the coupling configuration at which the hook portion 212 extends out from vertical lower section 211 at a first orientation with the hook portion 212 extending radially out from the vertical lower section 211 at a first, skewed angular orientation, such as that orientation shown at FIG. 2E. Then, when the hook portion 212 is moved into contact (e.g., along the installation axis) with the rail 204, such as shown at FIG. 2H, the hook portion 212 can move from the biased, coupling configuration, such as shown at FIG. 2G, to a receptacle entry configuration, such as shown at FIG. 2H.

For example, hook portion 212 can be moved from its biased, coupling configuration to the receptacle entry configuration as a result of bringing the hook portion 212 into contact with a wall of rail 204 forming frame receiving receptacle 209, such as shown at FIG. 2H. For instance, frame receiving receptacle 209 can be formed by first rail wall portion 282 and second rail wall portion 283. When hook portion 212 is moved into contact with first rail wall portion 282, first rail wall portion 282 can be configured to contact second hook portion 212b and apply first hook deformation force 278 at second hook portion 212 while second rail wall portion 283 is configured to contact vertical lower section 211 and apply counter force 279. Moving hook portion 212 into contact with rail 204 (e.g., into contact with wall portions 282, 293) to apply forces 278, 279 can cause the second hook portion 212b to deflect in direction 280 (e.g., second hook portion 212b is configured to deflect in direction 280 toward vertical lower section 211). With the hook portion 212 moved from its biased, coupling configuration to the receptacle entry configuration, the hook portion 212 in the receptacle entry configuration can be moved within frame receiving receptacle 209. For example, when hook portion 212 is in the biased, coupling configuration the hook portion 212 can extend out radially a distance that impeded or blocks hook portion 212 from entering opening 288, but when hook portion 212 is in the receptacle entry configuration, the hook portion 212 can be moved in the direction 280 to reduce the radial extent of the hook portion 212 to pass through opening 288 between wall portions 282, 283.

At step 293, the method 290 includes moving the hook portion from the receptacle entry configuration to the biased, coupling configuration to couple the frame component 206 to the rail 204. FIG. 2I shows an example of the hook portion 212 moved from the receptacle entry configuration at FIG. 2H to back to the biased, coupling configurations of FIGS. 2G and 2I. Because the hook portion 212 can be biased to the coupling configuration shown at FIG. 2I, once the hook portion has passed through the opening 288 and into the frame receiving receptacle 209, the hook portion can move back to the biased, coupling configuration. For instance, once the deformation force 278 imparted at the hook portion 212 by the wall portion 282 applied at FIG. 2H is removed (e.g., once the hook portion 212 is moved within frame receiving receptacle 209 to remove contact between the hook portion 212 and the wall portion 282), the hook portion can spring back to its biased, coupling configurations of FIGS. 2G and 2I. When the hook portion 212 is in the biased coupling configuration within the frame receiving receptacle 209, the hook portion 212 can be configured to contact a lower portion of wall 282 that faces torque tube 14 to apply a retention force 281 at hook portion 212 to maintain hook portion 212 within frame receiving receptacle 209.

The method 290 can include addition step(s) to couple a second solar module frame component (e.g., 206A) to the same rail 204 at which the first solar module frame component 206B is coupled. Thus, rail 204 can be configured to receive a pair of solar module frame components 206A, 206B and couple the pair of solar module frame components 206A, 206B to torque tube 14 using the engageable hook portion 2121, 212b at the frame components 206A, 206B and the pair of fame receiving receptacles 208, 209 at rail 204.

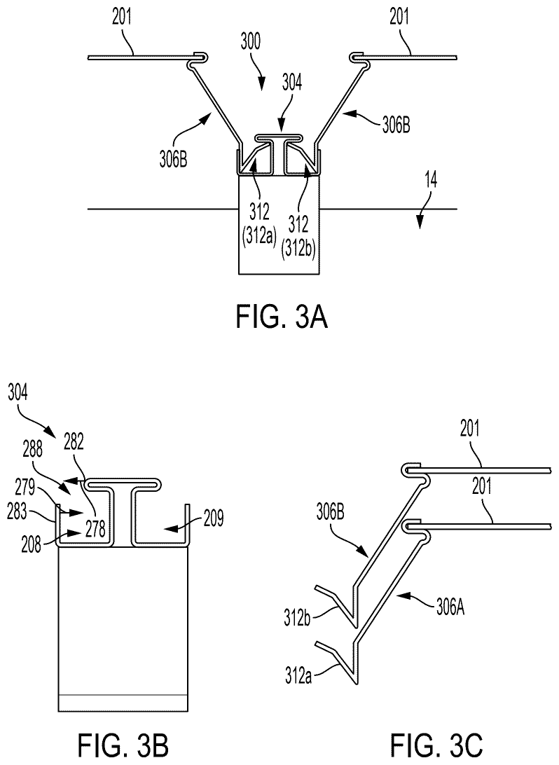

FIGS. 3A-3C illustrate another embodiment of a hooked flange solar module frame coupling apparatus 300. The hooked flange solar module frame coupling apparatus 300 of FIGS. 3A-3C can be similar to, or the same as, the hooked flange solar module frame coupling apparatus 200 of FIGS. 2A-2J except that the orientation of the hook portion 312 of the frame component 306 can have an inverse configuration as the hook portion 212 of the frame component 206 of the hooked flange solar module frame coupling apparatus 200 of FIGS. 2A-2J. FIG. 3A is a side elevational view of this embodiment of the hooked flange solar module frame coupling apparatus 300, FIG. 3B is a side elevational view of rail 304 component of this embodiment of the hooked flange solar module frame coupling apparatus 300, and FIG. 3C is a side elevational view of two stacked frame components 306A, 306B of this embodiment of the hooked flange solar module frame coupling apparatus 300.

The hooked flange solar module frame coupling apparatus 300 can be similar to, or the same as, the hooked flange solar module frame coupling apparatus 200 except that the orientation of the hook portion 312 of the frame component 306 can have an inverse configuration as the hook portion 212 described previously. The hook portion 312, like the hook portion 212, can be configured to move from the biased, coupling configuration to the receptacle entry configuration as a result of bringing the hook portion 312 into contact with the rail 304, for instance, as described with respect to the prior embodiment and shown here for the hooked flange solar module frame coupling apparatus 300. Thus, hook portion 312a of frame component 306A can be configured to move from the biased, coupling configuration to the receptacle entry configuration as a result of bringing the hook portion 312a into contact with the rail 304, and hook portion 312b of frame component 306B can be configured to move from the biased, coupling configuration to the receptacle entry configuration as a result of bringing the hook portion 312b into contact with the rail 304. The configuration of the hook portion 312 for the hooked flange solar module frame coupling apparatus 300 can help to increase a packing density of solar module frame components 306A, 306B, such as shown at FIG. 3C.

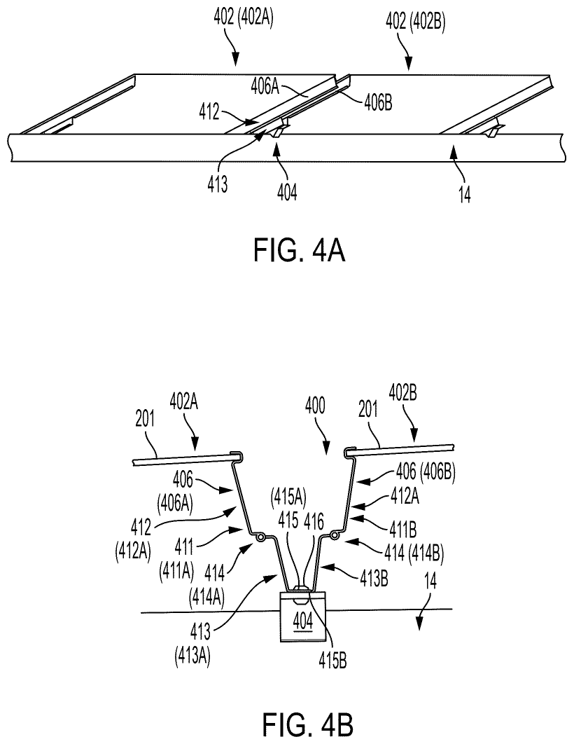

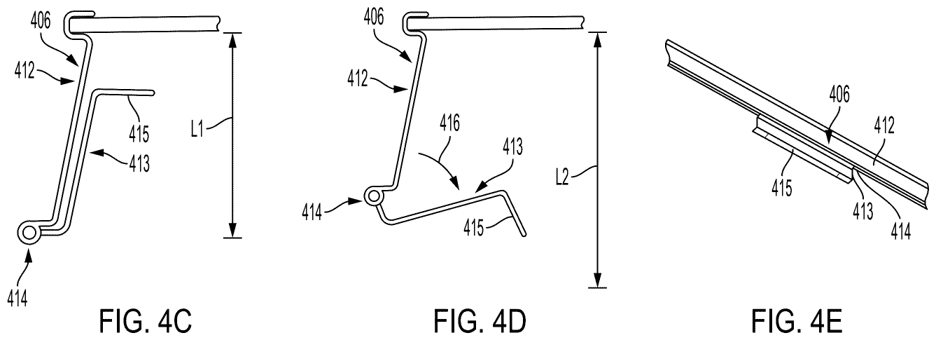

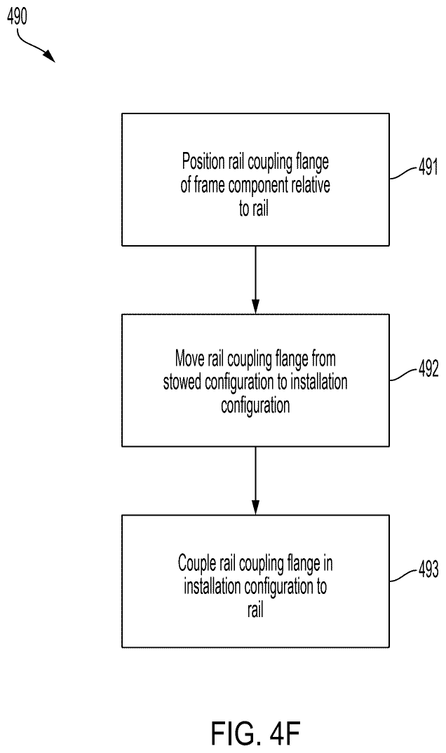

FIGS. 4A-4F illustrate an embodiment of a rotational frame solar module frame coupling apparatus 400. FIG. 4A is a perspective view and FIG. 4B is a side elevational view of the rotational frame solar module frame coupling apparatus 400 coupling solar modules 402 (first solar module 402A, second solar module 402B) to torque tube 14 of a solar tracker. FIGS. 4C-4E illustrate an embodiment of a sequence for rotating a frame component 406 of the rotational frame solar module frame coupling apparatus 400 from a stowed configuration, at FIG. 4C, to an installation configuration, at FIG. 4E, at which the frame component 406 can be coupled to rail component 404 of the rotational frame solar module frame coupling apparatus 400.

The rotational frame solar module frame coupling apparatus 400 include at least one solar module 402 and at least one rail component 404. For instance, the rotational frame solar module frame coupling apparatus 400 can be configured to couple a pair of solar modules 402A, 402B to torque tube 14.

The solar module 402 includes frame component 406. The frame component 406 can include rail coupling flange 411, and rail coupling flange 411 can be configured to couple to rail 404 to couple solar module frame component 406 to rail 404. The rail coupling flange 411 can include upper coupling flange portion 412 and lower coupling flange portion 413. The lower coupling flange portion 413 can include rail coupling interface 415 that is configured to interface with rail 404 and to receive a fastener 416 therethrough to couple frame component 406 to rail 404. The lower coupling flange portion 413 can be rotatably connected to the upper coupling flange portion 412 at rotatable connection 414 such that at least one the lower and upper coupling flange portions 413, 412 is rotatable relative to the other of the lower and upper coupling flange portions 413, 412 about rotatable connection 414. For example, rail coupling flange 411 can be movable about the rotatable connection 414 between a stowed configuration and an installation configuration. Moving lower coupling flange portion 413 relative to upper coupling flange portion 412 about rotatable connection 414 can result in moving rail coupling interface 415 relative to upper coupling flange portion 412 about rotatable connection 414.

FIG. 4C shows one example of a stowed configuration of the rail coupling flange 411 at the frame component 406. In this example stowed configuration, the rail coupling flange 411 has a first length L1. For instance, in one exemplary stowed configuration, the lower coupling flange portion 413 can extend generally parallel to the upper coupling flange portion 412 along parallel axes and the rail coupling interface 415 at the lower coupling flange portion 413 can be located above the rotatable connection 414.

FIG. 4D shows the rail coupling flange 411 moving from the stowed configuration of FIG. 4C toward the installation configuration of FIG. 4E. To move the rail coupling flange 411 from the stowed configuration to the installation configuration, the rail coupling flange 411 is moved about the rotatable connection 414, for instance in direction 416. Moving the rail coupling flange 411 about the rotatable connection 414 from the stowed configuration to the installation configuration can include moving the rail coupling interface 415 at the lower coupling flange portion 413 from a location above the rotatable connection 414 at the stowed configuration to a location below the rotatable connection 414 at the installation configuration. In the installation configuration, the rail coupling flange 411 can have a second length L2 that is greater than the length L1 when the rail coupling flange 411 in the stowed configuration.

When the rail coupling flange 411 is moved to the installation configuration, the rail coupling flange 411 can be coupled to rail 404. For example, in the installation configuration, the rail coupling flange can have the rail coupling interface 415 placed to interface with rail 404, and fastener can be driven through rail coupling interface 415. For instance, as shown at FIG. 4B, a pair of modules 402A, 402B can be coupled to rail 404 when first rail coupling flange 411A of first frame component 406A of first module 402A and when second rail coupling flange 411B of second frame component 406B of second module 402B are each in the installation configuration, such as shown at the example of FIG. 2B.

FIG. 4F is a flow diagram of an embodiment of a method 490 for coupling solar module 402 to torque tube 14 of a solar tracker using the rotational frame solar module frame coupling apparatus 400.

At step 491, the method 490 includes positioning rail coupling flange 411 of frame component 406 relative to rail 404. And at step 492, the method 490 includes moving the rail coupling flange 411 from the stowed configuration to the installation configuration. Depending on the application of the method 490, step 491 can precede step 492 or step 482 can precede step 491.

At step 492, once the rail coupling flange 411 is in the installation configuration, method 490 includes coupling the rail coupling flange 411 in the installation configuration to the rail 404. For example, step 492 can include inserted fastener 416 through rail coupling interface 415 that is positioned to face and contact rail 404 in the installation configuration.

The method 490 can include addition step(s) to couple a second solar module frame component (e.g., 406B) to the same rail 404 at which the first solar module frame component 406A is coupled. Thus, rail 404 can be configured to receive a pair of solar module frame components 406A, 406B and couple the pair of solar module frame components 406A, 406B in the installation configuration to torque tube 14 using the movable rail coupling flanges 411 at each of the pair of solar module frame components 406A, 406B. For instance, at shown at the example of FIG. 4B, a pair of rail coupling interface 415A, 415B of the solar module frame components 406A, 406B can be stacked to interface with the rail 404 and fastener 416 can be driven through the stack of the pair of rail coupling interface 415A, 415B and into the rail 404.

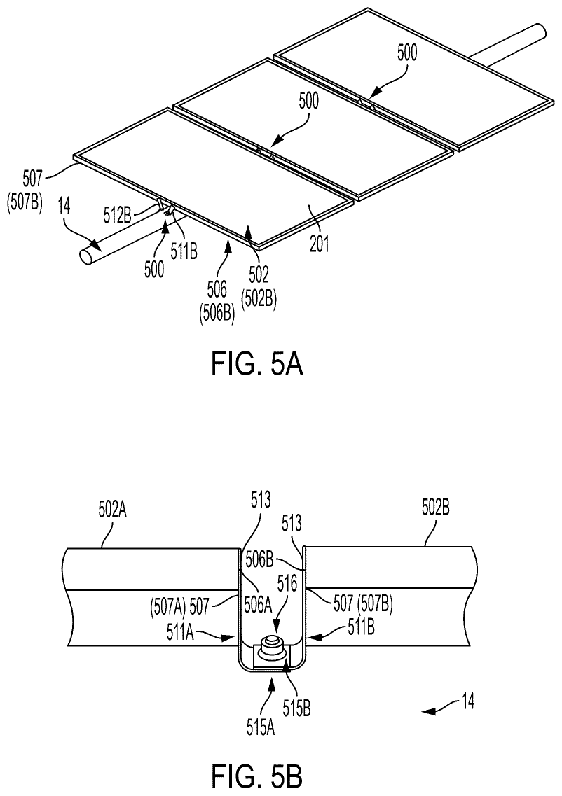

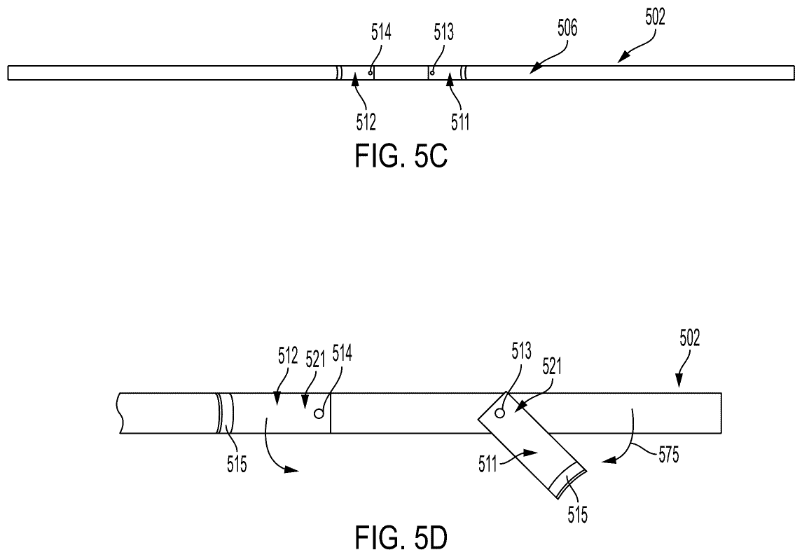

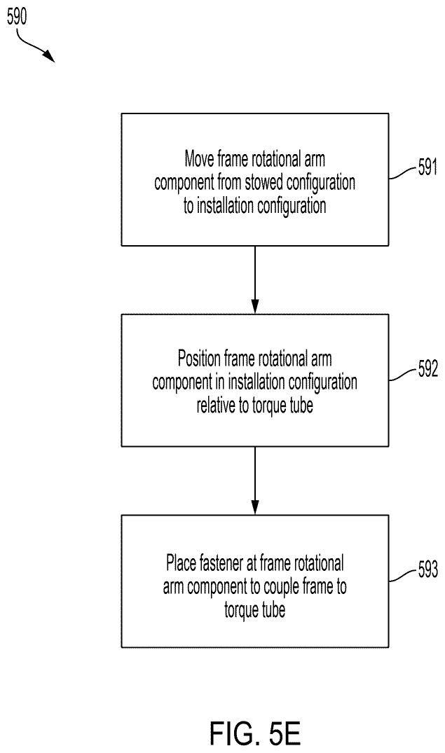

FIGS. 5A-5E illustrate an embodiment of a frame rotational arm solar module frame coupling apparatus 500. FIG. 5A is a perspective view and FIG. 5B is a side elevational view of the frame rotational arm solar module frame coupling apparatus 500 coupling solar modules 502 to torque tube 14 of a solar tracker. FIG. 5C is a side elevational view of the of a frame rotational arm component 511 of solar module frame 506 of the frame rotational arm solar module frame coupling apparatus 500, in a stowed configuration, and FIG. 5D a side elevational view of the of the frame rotational arm component 511 in an installation configuration.

The frame rotational arm solar module frame coupling apparatus 500 includes the solar module frame 506. The solar module frame 506 includes at least one frame rotational arm component 511. The illustrated embodiment of the solar module frame 506 here includes a pair of frame rotational arm components 511, 512. Each frame rotational arm component 511, 512 can be rotatably coupled to solar module frame 506. For example, frame rotational arm component 511 can be rotationally coupled to frame 506 at first rotatable connection 513 and frame rotational arm component 512 can be rotationally coupled to frame 506 at second rotatable connection 514. Each frame rotational arm component 511, 512 can include an arm base 521 and rail coupling interface 515. Arm base 521 can include an aperture to receive a rotatable coupler to rotatably couple frame rotational arm component 511, 512 to frame 506 (e.g., to a side surface of frame 506). Coupling interface 515 can be configured to interface with (e.g., contact) torque tube 14 when the frame rotational arm component 511, 512 is in the installation configuration so as to couple frame rotational arm component 511, 512 to torque tube 14.

FIG. 5C shows each frame rotational arm component 511, 512 in an exemplary stowed configuration. As shown here, each frame rotational arm component 511, 512 can be generally parallel with a longitudinal axis of a side surface of frame 506 when in the stowed configuration. For instance, when in the stowed configuration, each frame rotational arm component 511, 512 can be generally flush with longitudinal side surface of frame 506. In the stowed configuration, the coupling interface 515 at each frame rotational arm component 511, 512 can be positioned at or above a lower surface 507 of frame 506 (e.g., and not below the lower surface 507 of frame 506).

FIG. 5D shows frame rotational arm component 511, moving from the stowed configuration at FIG. 5C to the installation configuration shown at FIG. 5B. For example, to move from the stowed configuration to the installation configuration, the frame rotational arm component 511 can rotate about the first rotatable connection 513 in direction 575. When in the installation configuration, the coupling interface 515 at the frame rotational arm component 511 can be positioned below the lower surface 507 of frame 506 so as to interface with torque tube 14. And, when the frame rotational arm component 511 is in the installation configuration, a fastener 516 can be driven through the coupling interface 515.

FIG. 5E is a flow diagram of an embodiment of a method 590 for coupling a solar module 502 to torque tube 14 of a solar tracker using the frame rotational arm solar module frame coupling apparatus 500.

At step 591, the method 590 includes moving at least one frame rotational arm component 511, 512 from a stowed configuration to an installation configuration. And at step 592, the method 590 includes positioning the frame rotational arm component 511, 512, in the installation configuration, relative to torque tube 14. When the frame rotational arm component 511, 512 is in the installation configuration, a coupling interface 515 at the respective frame rotational arm component 511, 512 can define a lowest surface at the frame 506, but when the frame rotational arm component 511, 512 is in the stowed configuration, coupling interface 515 at the respective frame rotational arm component 511, 512 may not define a lowest surface at the frame 506.

At step 593, the method 500 includes placing a fastener at the frame rotational arm component 511, 512, in the installation configuration, to couple the frame 506 to the torque tube 14. For instance, the frame 506 can be coupled directly to torque tube 14 via one two or more of the frame rotational arm components 511 and 512 and without using a rail component between the frame 506 and torque tube 14.

As seen at FIG. 5B, the method 590 can include addition step(s) to couple a second solar module frame component (e.g., 506B) to the same torque tube 14 at which the first solar module frame component 506A is coupled. Thus, a frame rotational arm component 511A at one side of the frame 506A can be moved from the stowed to the installation configuration and the coupling interface 515A at the frame rotational arm component 511A at frame 506A can be placed adjacent torque tube 14, and, similarly, a frame rotational arm component 511B at an interfacing side of the frame 506B can be moved from the stowed to the installation configuration and the coupling interface 515B at the frame rotational arm component 511B at frame 506B can be placed adjacent torque tube 14. This can include placing the coupling interfaces 515A, 515B at the frame rotational arm component 511A, 511B in a stacked arrangement and driving a single fastener 516 through each of the stacked coupling interfaces 515A, 515B adjacent torque tube 14.

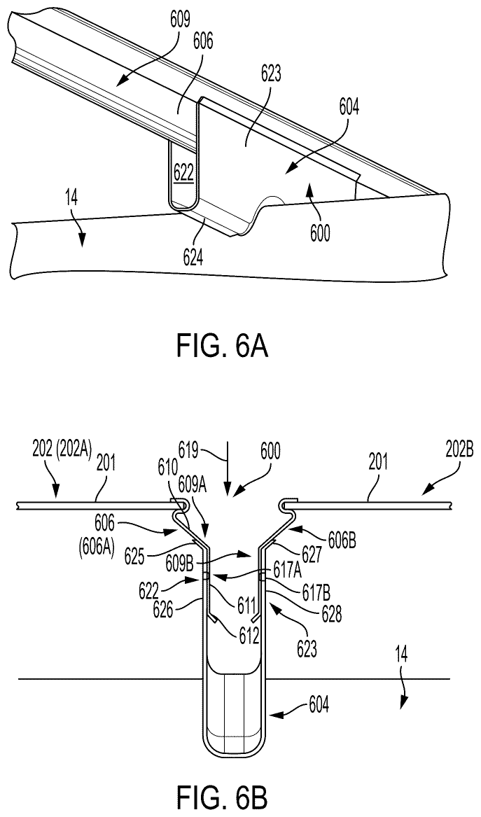

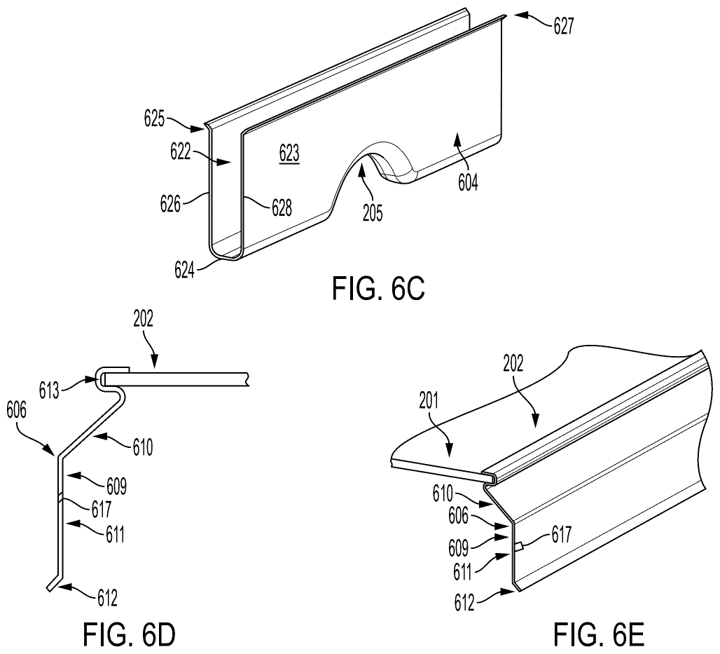

FIGS. 6A-6E illustrate an embodiment of a vertical solar module frame coupling apparatus 600. FIG. 6A is a perspective view and FIG. 6B is a side elevational view of the vertical solar module frame coupling apparatus 600. FIG. 6C is a perspective view of a rail 604 component of the vertical solar module frame coupling apparatus 400. FIG. 6D is a side elevational view and FIG. 6E is a perspective view of a frame 606 component of the vertical solar module frame coupling apparatus 400.

The vertical solar module frame coupling apparatus 600 can include at least one solar module frame 606 and at least one rail 604. The frame 606 can couple to the rail 604 which can couple to torque tube 14 such that the rail 604 can support the frame 606 at the torque tube 14. For example, the illustrated embodiment of the rail 604 is configured to couple to and support a pair of solar modules 202A, 202B at the torque tube 14. Namely, common rail 604 can be configured to receive and support frame 606A of solar module 202A and frame 606B of solar module 202B.

The solar module frame 606 can include mounting flange 609. The mounting flange 609 can include angled upper section 610, rail coupling interface section 611, and lower positioning section 612. The angled upper section 610 can define a photovoltaic receptacle 613 that is configured to receive and hold a photovoltaic substrate 201 (e.g., a PV laminate). The angled upper section 610 can extend at a non-zero angle relative to the rail coupling interface section 611 (e.g., which can extend vertically), such as at a skewed angle ranging from ten to eighty degrees, such as from thirty five to fifty five degrees relative to the rail coupling interface section 611. The skewed angular orientation of the angled upper section 610 can help to increase packing density for shipping and can allow for use of thinner profile rail component 606. The rail coupling interface section 611 can extend generally vertically from the angled upper section 610 and can bridge between the angled upper section 610 and the lower positioning section 612. The rail coupling interface section 611 can include a shear connection joint 617 that can be configured to provide a joint connection with the rail 604 as a result of an applied shear coupling force, such as a result of an applied shearing coupling force in direction 619. The lower positioning section 612 can extend out radially from the rail coupling interface section 611 in a direction away from the photovoltaic receptacle 613. The lower positioning section 612 can be configured to provide a north-south tactile positioning indication during installation at rail 604 with such tactile feedback between the lower positioning section 612 and the rail 604 providing an indication of proper relative positioning the frame 606 relative to rail 604 in a north-south direction.

The rail 604 can be a generally U-shaped profile. The rail 604 can include first rail sidewall 622, second rail sidewall 623, and rail base 624. The first rail sidewall 622 can be opposite the rail base 624 from the second rail sidewall 623. The rail base 624 can be configured to interface with torque tube 14, such as by contacting and securing to torque tube 14 at rail base 624. First rail sidewall 622 can include first angled upper rail wall section 625 and first vertical rail wall section 626, and second rail sidewall 623 can include second angled upper rail wall section 627 and second vertical rail wall section 628. First angled upper rail wall section 625 can extend out from first vertical rail wall section 626 at a skewed angle, for instance, that is complementary to the skewed extension angle of angled upper section 610 at frame 606. Namely, first angled upper rail wall section 625 can extend out from first vertical rail wall section 626 at a skewed angle such that first angled upper rail wall section 625 is configured to interface and sit along at least a portion of the angled upper section 610 at frame 606 (e.g., frame 606A). Similarly, second angled upper rail wall section 627 can extend out from second vertical rail wall section 628 at a skewed angle, for instance, that is complementary to the skewed extension angle of angled upper section 610 at frame 606. Namely, second angled upper rail wall section 627 can extend out from second vertical rail wall section 628 at a skewed angle such that first angled upper rail wall section 625 is configured to interface and sit along at least a portion of the angled upper section 610 at frame 606 (e.g., frame 606A). For instance, first angled upper rail wall section 625 can extend out from first vertical rail wall section 626 at a skewed angle that is the same angle of extent of the angled upper section 610 at frame 606A, and second angled upper rail wall section 627 can extend out from second vertical rail wall section 628 at a skewed angle that is the same angle of extent of the angled upper section 610 at frame 606B.

The first vertical rail wall section 626 at the first rail sidewall 622 can be configured to interface and couple to rail coupling interface section 611 at frame 606A, and the second vertical rail wall section 628 at the second rail sidewall 623 can be configured to interface and couple to rail coupling interface section 611 at frame 606B. For example, first vertical rail wall section 626 can be configured to couple to frame 606A at shear connection joint 617A at rail coupling interface section 611 of frame 606A, and second vertical rail wall section 628 can be configured to couple to frame 606B at shear connection joint 617B at rail coupling interface section 611 of frame 606B. An appropriate fastening mechanism (e.g., clinch joint, rivet, spot weld, etc.) can be placed at the interface between first vertical rail wall section 626 of rail 604 and rail coupling interface section 611 of frame 606A and at the interface between second vertical rail wall section 628 of rail 604 and rail coupling interface section 611 of frame 606B.

For example, frame 606A can be positioned relative to rail 604 by positioning mounting flange 609A relative to first rail sidewall 622. This could include placing angled upper section 610 into contact with first angled upper rail wall section 625 and placing rail coupling interface section 611 against first vertical rail wall section 626 upon moving frame 606A in the direction 619. Then a first fastening mechanism can be placed at the interface of the rail coupling interface section 611 against first vertical rail wall section 626. Similarly, frame 606B can be positioned relative to rail 604 by positioning mounting flange 609B of frame 606B relative to second rail sidewall 623. This could include placing angled upper section 610 into contact with second angled upper rail wall section 627 and placing rail coupling interface section 611 against second vertical rail wall section 628 upon moving frame 606B in the direction 619. Then a second fastening mechanism can be placed at the interface of the rail coupling interface section 611 against second vertical rail wall section 628.

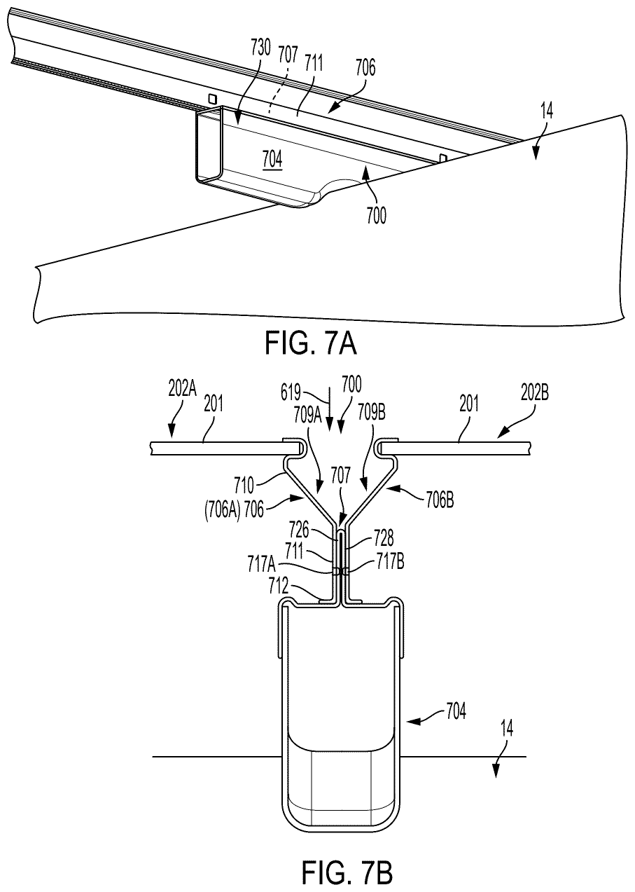

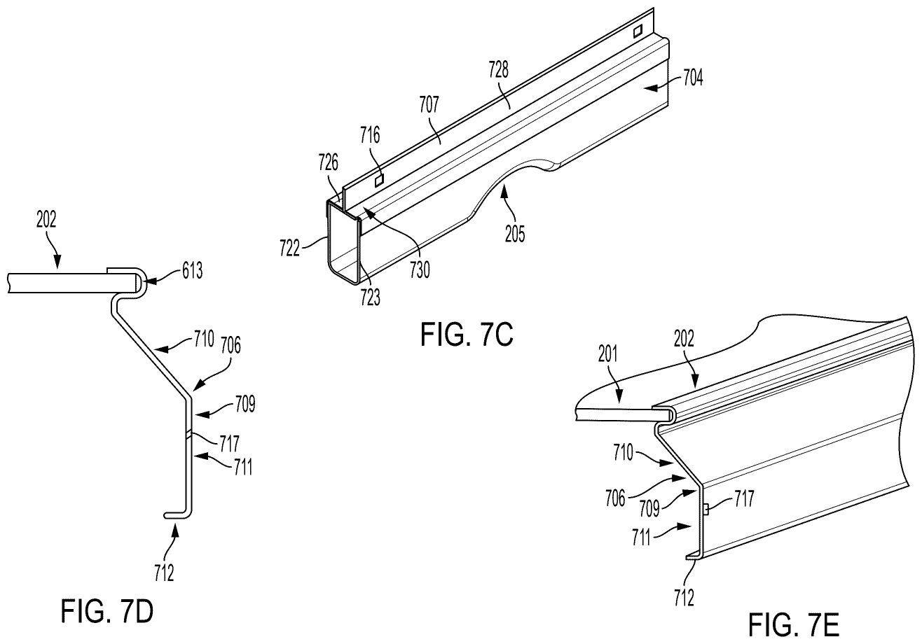

FIGS. 7A-7E illustrate an embodiment of a vertical rail tab solar module frame coupling apparatus 700. For example, the vertical rail tab solar module frame coupling apparatus 700 can be similar in installation to the vertical solar module frame coupling apparatus 600 of FIGS. 6A-6E but that the coupling location of frame mounting flanges at the rail is at a different location at the rail and the frame structure is altered according to better facilitate this different frame mounting flange-rail coupling location at the rail. FIG. 7A is a perspective view and FIG. 7B is a side elevational view of the vertical rail tab solar module frame coupling apparatus 700. FIG. 7C is a perspective view of a rail 704 component of the vertical rail tab solar module frame coupling apparatus 700. FIG. 7D is a side elevational view and FIG. 7E is a perspective view of a frame 706 component of the vertical rail tab solar module frame coupling apparatus 700.

The vertical rail tab solar module frame coupling apparatus 700 can include the rail 704 and at least one solar module frame 706. The frame 706 can couple to the rail 704 which can couple to torque tube 14 such that the rail 704 can support the frame 706 at the torque tube 14. For example, the illustrated embodiment of the rail 704 is configured to couple to and support a pair of solar modules 202A, 202B at the torque tube 14. Namely, common rail 704 can be configured to receive and support frame 706A of solar module 202A and frame 706B of solar module 202B.

The solar module frame 706 (e.g., first solar module frame 706A, second solar module frame 706B) can include mounting flange 709. The mounting flange 709 can include angled upper section 710, rail coupling interface section 711, and lower positioning section 712. The angled upper section 710 can define photovoltaic receptacle 613 that is configured to receive and hold a photovoltaic substrate 201 (e.g., a PV laminate). The angled upper section 710 can extend at a non-zero angle relative to the rail coupling interface section 711 (e.g., which can extend vertically), such as at a skewed angle ranging from ten to eighty degrees, such as from thirty five to fifty five degrees relative to the rail coupling interface section 711. The rail coupling interface section 711 can extend generally vertically from the angled upper section 710 and can bridge between the angled upper section 710 and the lower positioning section 712. The rail coupling interface section 711 can include a shear connection joint 717 that can be configured to provide a joint connection with the rail 704 as a result of an applied shear coupling force, such as a result of an applied shearing coupling force in direction 619. The lower positioning section 712 can extend out radially from the rail coupling interface section 711 in a direction toward from the photovoltaic receptacle 613. The lower positioning section 712 can be configured to provide a north-south tactile positioning indication during installation at rail 704 with such tactile feedback between the lower positioning section 712 and the rail 704 providing an indication of proper relative positioning the frame 706 relative to rail 704 in a north-south direction.

The rail 704 can include protruded mounting tab 707. The protruded mounting tab 707 can be configured to couple to one solar module frame 706A at one side and configured to couple to another solar module frame 706B at another, opposite side of the protruded mounting tab 707. For instance, rail 704 as illustrated for the exemplary embodiment includes rail cap 730 that includes protruded mounting tab 707. Rail cap 730 can be positioned at a top of the rail 704 to bridge between first rail sidewall 722 and second rail sidewall 723. The frames 706A, 706B can be coupled to the protruded mounting tab 707 at the rail 706 similar to that described for coupling the frames 606A, 606B to the frame 604 at FIGS. 6A-6E. Specifically, one side of the protruded mounting tab 707 can define first vertical rail wall section 726 for interfacing with rail coupling interface section 711 of mounting flange 709 of first frame 706A, and the other, opposite side of the protruded mounting tab 707 can define second vertical rail wall section 728 for interfacing with rail coupling interface section 711 of mounting flange 709 of first frame 706B. The illustrated embodiment shows one or more coupling apertures 716 at the protruded mounting tab 707 for alignment with one or more flange coupling apertures 717 when the rail 706 is so placed relative to the protruded mounting tab 707. A fastening mechanism can be placed at the interfacing vertical wall section and rail coupling interface sections at each side of the protruded mounting tab 707.

In one specific embodiment of the vertical rail tab solar module frame coupling apparatus 700, each of the frame 706 and the rail 704 can include a lateral retention member that when engaged can be configured to self-center the frame 706 at the rail 704. For instance, this could engage the lateral retention member at each of the frame 706 and rail 704 being configured to self-center the frame 706 in an east-west direction along the rail 704. As one example, the frame 706 can include a first lateral retention member and the rail 704 can include a second lateral retention member that is complementary to the first lateral retention member such that when the first and second lateral retention members are engaged via engagement of the frame 706 at the rail 704 the frame 706 is retained at the rail 704 at a relatively central position along the rail 704 in an east-west direction along the rail 704. One specific such example can include complementary, V-shaped cross-sectional profile lateral retention members, with a V-shaped cross-sectional first lateral retention member at the frame 706 that is configured to engage with a complementary, V-shaped cross-sectional second lateral retention member at the rail 704 to retain and center the frame 706 in an east-west direction along the rail 704.

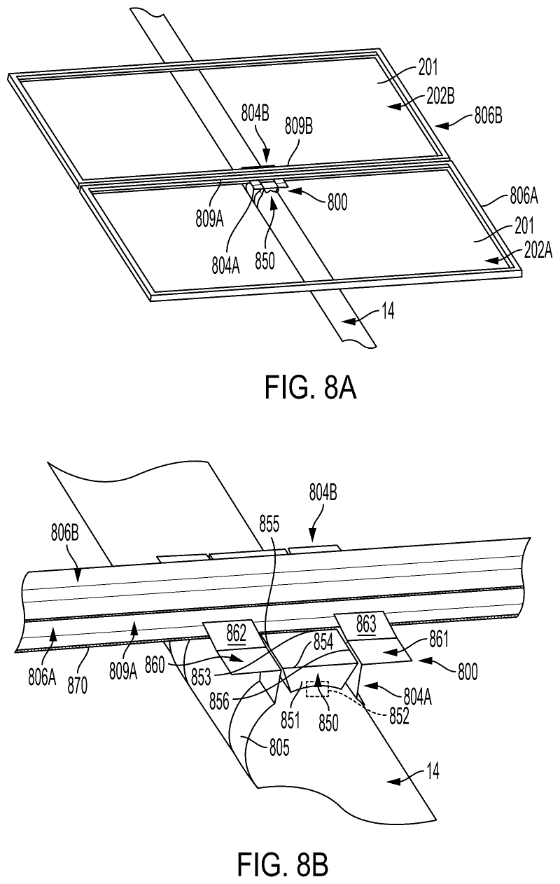

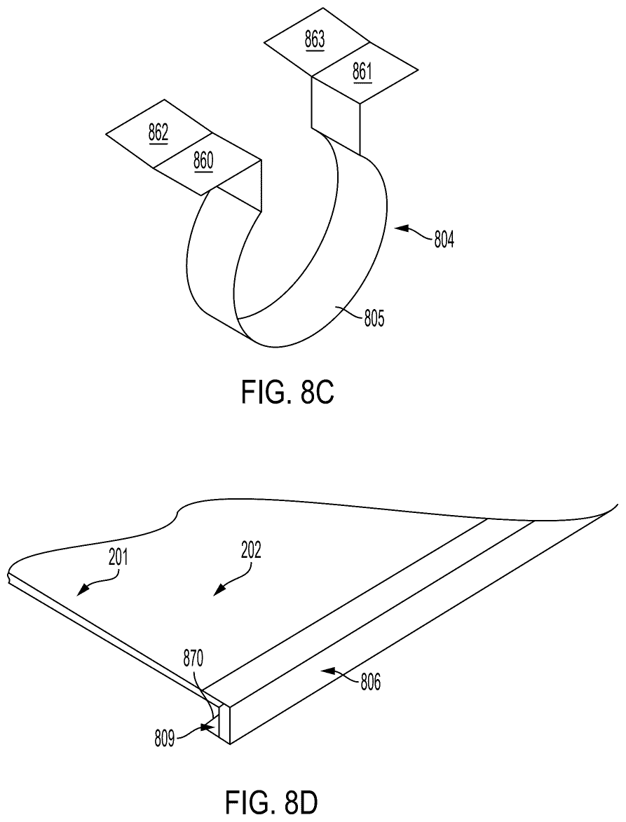

FIGS. 8A-8D illustrate an embodiment of a standoff rail solar module frame coupling apparatus 800. The standoff rail solar module frame coupling apparatus 800 can include at least one solar module frame 806 (e.g., at least first solar module frame 806A and second solar module frame 806B), at least one standoff rail 804, and at least one standoff component 850. FIG. 8A is a perspective view of the standoff rail solar module frame coupling apparatus 800 coupling solar modules 202A, 202B to torque tube 14 of a solar tracker. FIG. 8B shows a closeup, detailed perspective view of FIG. 8A to show standoff rail 804A installed at the torque tube 14 to retain solar module 202A at the torque tube 14. FIG. 8C shows a perspective view of the standoff rail 804 of the standoff rail solar module frame coupling apparatus 800. FIG. 8D shows a perspective view of a portion of a standoff receiving channel 809 at solar module frame 806A for reception at the standoff rail 84 to retain the solar module frame 806A at torque tube 14.

The standoff component 850 can be configured to attach to torque tube 14. For example, standoff component 850 can include torque tube coupling section 851 that is configured to attach to torque tube aperture 852 to thereby retain the standoff component 850 at the torque tube 14, for instance at shown at the example of FIG. 8B. The standoff component 850 can include a first side 853 configured to interface with a perimeter of a first frame 806A and a second, opposite side 854 configured to interface with another frame. Radial side 855 can extend between sides 853, 854 and radial side 856 can extend between sides 853, 854 at an opposite side. Thus, the standoff component 850 can be configured to be positioned at the torque tube 14 and between adjacent pairs of solar module frames.

The standoff rail 804 can include strap 805, first side standoff interface 860, second side standoff interface 861, first side rail retention wing 862, and second side rail retention wing 863. Each of the first side standoff interface 860, second side standoff interface 861, first side rail retention wing 862, and second side rail retention wing 863 can be at the strap 805 such that as the strap 805 is positioned at the torque tube 14, each of the first side standoff interface 860, second side standoff interface 861, first side rail retention wing 862, and second side rail retention wing 863 are also positioned relative to torque tube 14. The first side standoff interface 860 and the first side rail retention wing 862 can be adjacent one another at one side of standoff rail 804 and the second side standoff interface 861 and the second side rail retention wing 863 can be adjacent one another at another side of standoff rail 804. The first side standoff interface 860 and second side standoff interface 861 can lay in a common plane with strap 805, while the first side rail retention wing 862 and the second side rail retention wing 863 can be offset from the plane within which the strap 805, first side standoff interface 860, and second side standoff interface 861 lay. In other words, the first side rail retention wing 862 and the second side rail retention wing 863 can be cantilevered from the respective first side standoff interface 860 and second side standoff interface 861 to extend out beyond the strap 805. This cantilevered, extension of the first side rail retention wing 862 and the second side rail retention wing 863 can configure each of the first and second side rail retention wings 862, 863 to engage with solar module frame 806 (e.g., to engage with solar module frame 806 at standoff receiving channel 809).

The at least one solar module frame 806 can define the standoff receiving channel 809. For example, the illustrated embodiment shows the frame 806 defining a generally C-shaped cross-section that includes the standoff receiving channel 809 as a lower surface of that generally C-shaped cross-section, with the standoff receiving channel 809 terminating at channel end surface 870. The standoff receiving channel 809 can be configured to receive the first side rail retention wing 862 and the second side rail retention wing 863 of the standoff rail 804 which can help to retain the frame 806 at torque tube 14.

To install standoff rail solar module frame coupling apparatus 800, the standoff component 850 can be placed at torque tube 14 (e.g., attached to torque tube 14 as described above). Then, the standoff rail 804 can be placed at the torque tube 14. For instance, the strap 805 can be pulled around torque tube 14 and over standoff component 850. Thus, the standoff component 850 can be retained at torque tube 14 in one direction via attachment between torque tube coupling section 851 and torque tube aperture 852 and the standoff component 850 can be retained at torque tube 14 in another, opposite direction via the strap 805 extending over standoff component 850. Then, fame 806A can be placed at standoff component 850 (e.g., placed in contact with strap 805 which is over standoff component 850) with first side rail retention wing 862 extending past channel end surface 870 and seated at the standoff receiving channel 809A and with second side rail retention wing 863 extending past channel end surface 870 and seated at the standoff receiving channel 809A. In this way, the standoff rail solar module frame coupling apparatus 800 can be configured to position and retain one or more solar module frames 806 at torque tube 14 with minimal to fastening costs and labor, thereby helping to reduce solar tracker installation costs.

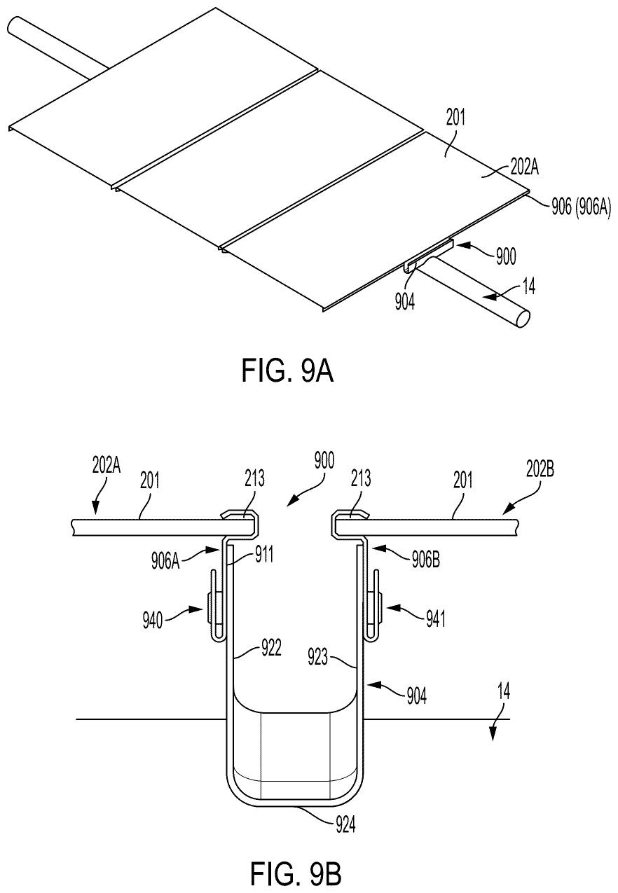

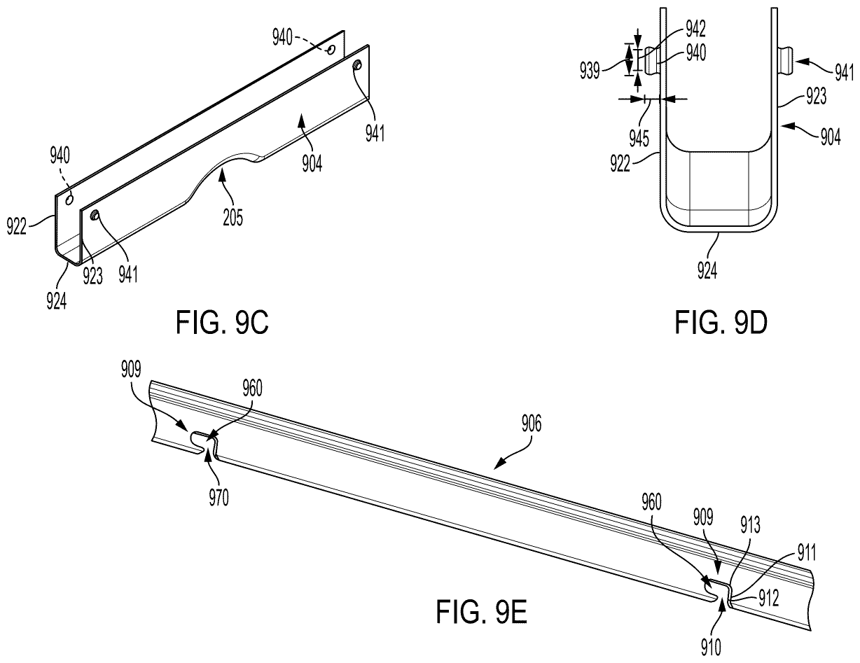

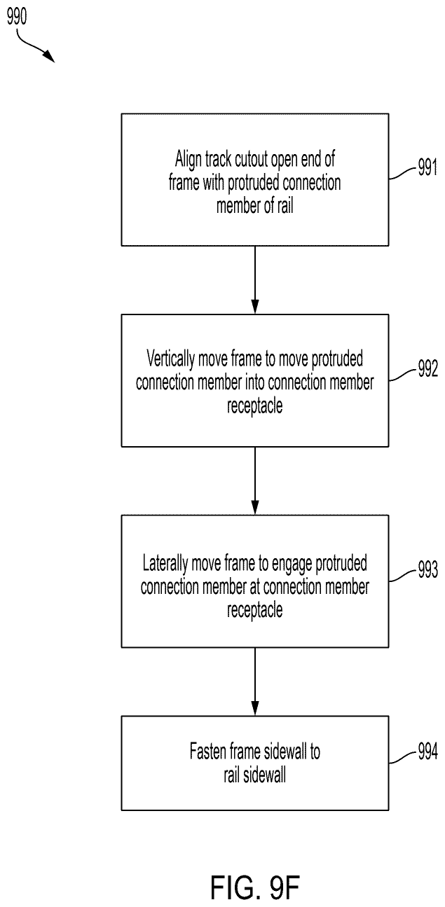

FIGS. 9A-9F illustrate an embodiment of a slide track solar module frame coupling apparatus 900. The slide track solar module frame coupling apparatus 900 can include at least one solar module frame 906 (e.g., first solar module frame 906A and second solar module frame 906B) and at least one rail 904. FIG. 9A is a perspective view and FIG. 9B is a side elevational view of the slide track solar module frame coupling apparatus 900 coupling solar modules 202A, 202B to a torque tube 14 of a solar tracker. FIGS. 9C is a perspective view and FIG. 9D is a side elevational view of a rail 904 component of the slide track solar module frame coupling apparatus 900. FIG. 9E is a perspective view of a frame 906 component of the slide track solar module frame coupling apparatus 900.

The rail 904 can be a generally U-shaped cross-sectional profile. The rail 904 can include first rail sidewall 922, second rail sidewall 923, and rail base 924. The first rail sidewall 922 can be opposite the rail base 924 from the second rail sidewall 923. The rail base 924 can be configured to interface with torque tube 14, such as by contacting and securing to torque tube 14 at rail base 924. First rail sidewall 922 can include at least one protruded connection member 940 that extends out radially from the first rail sidewall 922, and second rail sidewall 923 can include at least one protruded connection member 941 that extends out radially from the second rail sidewall 923. In some examples, such as that shown here at FIG. 9D, each of the protruded connection members 940, 941 can have a tapered width along a portion of its length extending out from the respective sidewall 922, 923. In one specific such example shown at FIG. 9D, each of the protruded connection members 940, 941 can have a first width 939 along a portion of length 945 that extends out from the respective sidewall 922, 923 and a second, different width 942 along another, different portion of length 945 that extends out from the respective sidewall 922, 923. For instance, as shown here, the second width 942 can be less than the first width 939, and each of the protruded connection members 940, 941 can have the second width 942 along a portion of the length 945 between two portions of the length 945 having the first width 939. Thus, each of the protruded connection members 940, 941 can have the first width 939 for a portion of the length 945 extending from the respective sidewall 922, 923, then have the second width 942 for a next portion of the length 945 projecting out, and terminate at a free-floating end again with the first width 939.

The frame 906 can include one or more track cutouts 909. The track cutout 909 can be configured to receive and engage an aligned protruded connection member 940, 941. The track cutout 909 can be defined with an open end 910 at a lower surface of the frame 906 and a connection member receptacle 960 above the open end 910. As one example shown here, the track cutout 909 can be formed by first frame sidewall 911, second frame sidewall 912, and intermediate sidewall gap 913. The first frame sidewall 911, the second frame sidewall 912, and the intermediate sidewall gap 913 can bound the connection member receptacle 960, while the open end 910 defines an opening in each of the first frame sidewall 911, the second frame sidewall 912, and the intermediate sidewall gap 913. The track cutout 909 can be configured to first receive a given protruded connection member 940, 941 via the open end 910 and to then pass the received, given protruded connection member 940, 941 into the connection member receptacle 960. The connection member receptacle 960 can have a greater width, as shown for instance at FIG. 9E, than the width of the open end 910 to help facilitate relative alignment of the given protruded connection member 940, 941 of the frame 906 relative to torque tube 14 by accommodating adjustment movement of the given protruded connection member 940, 941 relative to the rail 904 within the connection member receptacle 960. The track cutout 909 can be configured to engage the given protruded connection member 940, 941 at the connection member receptacle 960 with the first frame sidewall 911 at the innermost first, larger width 939, the second frame sidewall 912 at the outermost first, larger width 939, and with the intermediate sidewall gap 913 at the second, smaller width 942 at the given protruded connection member 940, 941.

FIG. 9F is a flow diagram of an embodiment of a method 990 for coupling a solar module to a torque tube of a solar tracker using the slide track solar module frame coupling apparatus 900.

At step 991, the method 900 includes aligning an open end of a track cutout at a solar module frame with a protruded connection member of a rail. For instance, this can include aligning open end 910 of track cutout 909 at solar module frame 906 with protruded connection member 940 or 941 of rail 904. This can include axially aligning open end 910 of track cutout 909 at solar module frame 906 with protruded connection member 940 or 941 of rail 904 along an axis of installation so that as the frame 906 is moved along this installation axis the open end 910 of track cutout 909 at solar module frame 906 encounters protruded connection member 940 or 941 at rail 904.

At step 992, the method 900 includes vertically moving the solar module frame to move the protruded connection member at the rail into the connection member receptacle at the track cutout at the frame. For instance, this can include moving solar module frame 906 vertically along the installation axis (e.g., along which the alignment occurred at step 991) to cause protruded connection member 940 or 941 at rail 904 to move through the open end 910 of track cutout 909 and into the connection member receptacle 960 at the track cutout 909 at frame 909.

At step 993, the method 900 includes laterally moving the solar module frame to engage the protruded connection member of the rail at the connection member receptacle of the frame. For instance, this can include, after vertically moving frame 906 to place protruded connection member 940 or 941 of rail 904 in the connection member receptacle 960 at step 992, laterally (e.g., in a direction normal to the direction at which the frame 906 is moved at step 992) moving frame 906 to engage the protruded connection member 940 or 941 of the rail 904 at the connection member receptacle 960 of the frame 906. As one such example, the frame 906 can be moved to engage the protruded connection member 940 or 941 of the rail 904 at the connection member receptacle 960 of the frame 906 by moving the frame laterally (e.g., in a direction normal to the direction at which the frame 906 is moved at step 992) to cause the connection member receptacle 960 to engage the protruded connection member 940 or 941 with the first frame sidewall 911 at the innermost first, larger width 939, the second frame sidewall 912 at the outermost first, larger width 939, and with the intermediate sidewall gap 913 at the second, smaller width 942 at the given protruded connection member 940, 941.

At step 994, the method 900 includes fastening a frame sidewall to a rail sidewall when the protruded connection member of the rail is engaged at the connection member receptacle of the frame. For instance, first rail sidewall 922 can be fastened to first frame sidewall 911 when protruded connection member 940 or 941 of rail 904 is engaged at connection member 960 receptacle of the frame 906. As one example, the fastening of the frame and rail sidewall can include a clinch joint, though in other examples other suitable fastening means can be utilized.

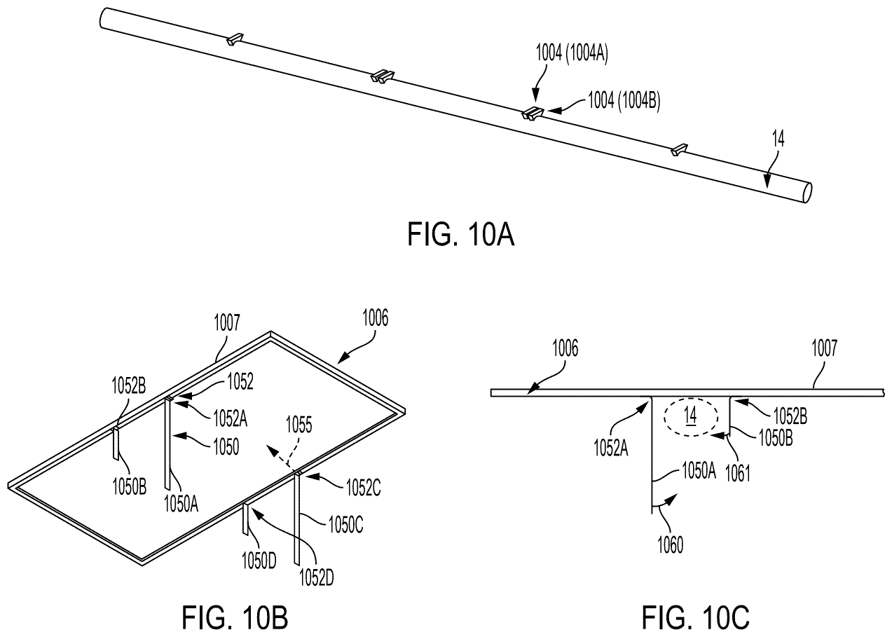

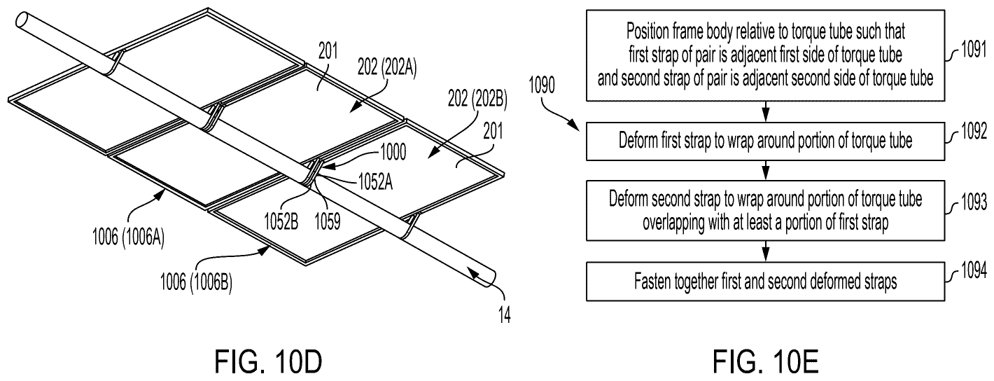

FIGS. 10A-10E illustrate an embodiment of a multi-strap rail solar module frame coupling apparatus 1000. FIG. 10A is a perspective view of torque tube 14 with rail 1004 components of the solar module frame coupling apparatus 1000 installed at the torque tube 14. FIG. 10B is a perspective view and FIG. 10C is a side elevational view of a multi-strap solar module frame 1006 in an installation configuration. FIG. 10D is a perspective view of the multi-strap solar module frame 1006 in a coupling configuration where the straps at the multi-strap solar module component are deformed relative to the installation configuration to couple the multi-strap solar module frame 1006 to the torque tube 14.

The multi-strap rail solar module frame coupling apparatus 1000 can include at least one rail 1004 and at least one multi-strap solar module frame 1006. The rail 1004 can be configured to be placed at torque tube 14, such as shown at the example of FIG. 10A. For instance, the rail 1004 can be configured to attach to the torque tube 14 such as disclosed with respect to standoff component 850 previously. The multi-strap solar module frame 1006 can be configured to couple to the rail 1004 to thereby couple the multi-strap solar module frame 1006 to torque tube 14, for instance, with reduced installation costs.

The multi-strap solar module frame 1006 can include frame body 1007 and one or more straps 1050. The illustrated embodiment shows the frame body 1007 having four straps 1050: first strap 1050A, second strap 1050B, third strap 1050C, and forth strap 1050D. First strap 1050A and second strap 1050B are at a same, first side (e.g., first longer, longitudinal side) of frame body 1007, and third strap 1050C and fourth strap 1050D are at a same, second side (e.g., second longer, longitudinal side) of frame body 1007 opposite the first side of frame body 1007. Thus, frame body 1007 can have one pair of straps 1050A, 1050B at one side and another pair of straps 1050C, 1050D at another, opposite side of frame body 1007. In some applications, the first and second straps 1050A, 1050B can be spaced apart along the first side by approximately 400 mm to correspond to pre-drilled hole locations in torque tube 14 in those applications. The first strap 1050A can be longer than the second strap 1050B, and the third strap 1050C can be longer than the fourth strap 1050D (and, in some such examples, the first and third straps 1050A. 1050C can be a same length and the second and fourth straps 1050B, 1050D can be a same length).

Each of the straps 1050A-1050D can be attached to the frame body 1007 via a pivot joint 1052. Namely, first strap 1050A can be attached to frame body 1007 at pivot joint 1052A, second strap 1050B can be attached to frame body 1007 at pivot joint 1052B, third strap 1050C can be attached to frame body 1007 at pivot joint 1052C, and fourth strap 1050D can be attached to frame body 1007 at pivot joint 1052D. Each of the straps 1050A-1050D can rotate relative to frame body 1007 about the respective pivot joint 1052A-1052D. For example, each of the straps 1050A-1050D can be configured to rotate relative to frame body 1007 about the respective pivot joint 1052A-1052D between an installation configuration, such as that shown at FIGS. 10B and 10C, and a stowed position. In the installation configuration, each of the straps 1050A-1050D can extend generally vertically out from a lower surface of frame body 1007, such as shown at FIGS. 10B and 10C. In the stowed position, each of the straps 1050A-1050D can be rotated about the respective pivot joint 1052A-1052D to a different orientation at which one or more (E.g., each) of the straps 1050A-1050D extends out less far from the frame body 1007 as compared to the installation configuration. For instance, in the stowed position, each of the straps 1050A-1050D can be rotated about the respective pivot joint 1052A-1052D to orient the straps 1050A-1050D in a direction toward the interior area of the frame 1006. This could include, in the stowed position, each of the straps 1050A-1050D can be rotated about the respective pivot joint 1052A-1052D to orient the straps 1050A-1050D in a direction toward the pair of straps at the opposite side of the frame body 1007. For example, in the stowed position, strap 1050C can be rotated about the respective pivot joint 1052A to orient the strap 1050A in the direction and plane indicated by arrow 1055.

To couple the frame 1006 to the rail 1004, one or more of the straps 1050A-1050D can be moved from the installation configuration to a torque tube wrapping configuration, such as shown at FIG. 10D. For example, referring to FIG. 10C, the frame 1006 with the straps 1050A-1050D can be placed relative to torque tube 14 such that each pair of straps 1050A, 1050B and 1050C, 1050D has one such strap of the pair at one side of torque tube 14 and the other such strap of the pair at the other, opposite side of torque tube 14. Then first strap 1050A can be rotated about pivot joint 1052A in a first direction 1060 toward torque tube 14 and second strap 1050B can be rotated about pivot joints 1052B in a second, opposite direction 1061 toward torque tube 14. This can cause first and second straps 1050A, 1050B to overlap along a length around torque tube 14, such as at overlapping strap region 1059 shown at FIG. 10E. Similarly, third strap 1050C can be rotated about pivot joint 1052C in a first direction 1060 toward torque tube 14 and fourth strap 1050D can be rotated about pivot joints 1052D in a second, opposite direction 1061 toward torque tube 14. This can cause third and fourth straps 1050C, 1050D to overlap along a length around torque tube 14 similar to the overlap 1059 shown for the first and second straps 1050A, 1050B.

FIG. 10E is a flow diagram of an embodiment of a method 1090 for coupling a solar module frame to a torque tube of a solar tracker using the multi-strap rail solar module frame coupling apparatus 1000.

At step 1091, the method 1090 includes positioning a frame body relative to a torque tube such that a first strap, in an installation position, of a first pair of straps at a first side of the frame body is adjacent to a first side of the torque tube and a second strap, in an installation configuration, of the first pair of straps at the first side of the frame body is adjacent to a second, opposite side of the torque tube. For instance, FIG. 10C shows an example positioning of a frame body 1007.

At step 1092, the method 1090 includes deforming the first strap of the first pair of straps from the installation configuration to wrap around at least a portion of the torque tube from the first side of the torque tube. This can include deforming the first strap from a vertical, hanging orientation relative to the frame body to orient the first strap toward the torque tube.

At step 1093, the method 1090 includes deforming the second strap of the first pair of straps from the installation configuration to wrap around at least a portion of the torque tube from the second side of the torque tube and with at least a portion of the first and second straps overlapping along at least a portion of a perimeter around the torque tube. This can include deforming the first strap from a vertical, hanging orientation relative to the frame body to orient the first strap toward the torque tube.

At step 1094, the method 1090 includes, after deforming the first and second straps (e.g., after steps 1092 and 1093, fastening together the first and second straps around the torque tube. As one such example, the first and second straps can be fastened together about the torque tube using a banding strap tensioning tool to apply tension to the first and second straps and then fastening together at least the overlapping portions of the first and second straps. For instance, the overlapping portion of the first and second straps can be clinched together or welded together to secure the frame to the torque tube using the multi-strap rail solar module frame coupling apparatus 1000.

Various examples have been described. These and other examples are within the scope of this disclosure and claims pursed from this disclosure.

What is claimed is:

1. A hooked flange solar module frame coupling apparatus comprising:
a solar module frame comprising a hook portion, the hook portion movable between a biased, coupling configuration and a receptacle entry configuration; and
a rail comprising a frame receiving receptacle,
wherein, when the hook portion engages the frame receiving receptacle, the hook portion is configured to move from the biased, coupling configuration to the receptacle entry configuration to receive the hook portion within the frame receiving receptacle, and
wherein, when the hook portion is received within the frame receiving receptacle, the hook portion is configured to move from the receptacle entry configuration to the biased, coupling configuration.

2. The apparatus of claim 1, wherein, when hook portion is in the biased, coupling configuration, the hook portion extends out radially a distance that blocks the hook portion from being received at an opening at the frame receiving receptacle.

3. The apparatus of claim 2, wherein, when the hook portion engages the frame receiving receptacle to move the hook portion from the biased, coupling configuration to the receptacle entry configuration, the distance at which the hook portion extends out radially is reduced to enable the hook portion to pass through the opening at the frame receiving receptacle.

4. The apparatus of claim 1, wherein the solar module frame further comprises a rail coupling flange having the hook portion, and wherein the rail coupling flange further comprises a vertical lower section and an angled upper section that defines a photovoltaic receptacle, the angled upper section extending from the vertical lower section at a skewed angle relative to the vertical lower section.

5. The apparatus of claim 4, wherein the angled upper section extends from the vertical lower section at the skewed angle ranging from thirty five to fifty five degrees relative to the vertical lower section.

6. The apparatus of claim 4, wherein the vertical lower section extends between the hook portion and the angled upper section.

7. The apparatus of claim 6, wherein the hook portion extends out radially from the vertical lower section in a same direction that the angled upper section extends out radially from the vertical lower section.

8. The apparatus of claim 7, wherein the hook portion comprises a first hook portion and a second hook portion, the first hook portion extending out radially from the vertical lower section along a first axis, the second hook portion extending out radially from the first hook portion along a second axis that is offset from the first axis.

9. The apparatus of claim 8, wherein the frame receiving receptacle is formed by a first rail wall portion and a second rail wall portion, wherein, when the hook portion is moved into contact with first rail wall portion, the first rail wall portion is configured to contact the second hook portion and apply a first hook deformation force at the second hook portion.

10. The apparatus of claim 9, wherein the second rail wall portion is configured to contact vertical lower section and apply a counter force, and wherein moving the hook portion into contact with the rail to apply the first hook deformation force and the counterforce causes the second hook portion to deflect in a direction toward the vertical lower section.

11. The apparatus of claim 7, wherein the rail comprises a semi-circular recess that is configured to contact and sit at a torque tube of a solar tracker.

12. The apparatus of claim 11, wherein the frame receiving receptacle is a first frame receiving receptacle, and wherein the rail further comprises a second frame receiving receptacle, the first frame receiving receptacle configured to engage with the hook portion of the solar module frame, and wherein the second frame receiving receptacle is configured to engage with a hook portion of a second, different solar module frame.

13. The apparatus of claim 7, wherein the frame receiving receptacle is configured to engage with the hook portion of the solar module frame to couple the solar module frame to the rail without a fastening component at the hook portion.

14. A method for coupling a solar module frame to a torque tube of a solar tracker comprising the steps of:
positioning a hook portion of a solar module frame relative to a frame receiving receptacle at a rail;
moving the hook portion from a biased, coupling configuration to a receptacle entry configuration as a result of contact between the hook portion and the rail; and
after moving the hook portion to the receptacle entry configuration, moving the hook portion from the receptacle entry configuration to the biased, coupling configuration to couple the solar module frame to the rail.

15. The method of claim 14, wherein the hook portion is moved from the biased, coupling configuration to a receptacle entry configuration when the hook portion contacts a rail wall portion at the rail, and wherein the frame receiving receptacle is defined by the rail wall portion.

16. The method of claim 15, wherein the hook portion is moved from the receptacle entry configuration to the biased, coupling configuration after the hook portion passes through an opening defined by the rail wall portion.

17. The method of claim 16, wherein, when hook portion is in the biased, coupling configuration, the hook portion extends out radially a distance that blocks the hook portion from being received at the opening at the frame receiving receptacle.

18. The method of claim 17, wherein, when the hook portion engages the frame receiving receptacle to move the hook portion from the biased, coupling configuration to the receptacle entry configuration, the distance at which the hook portion extends out radially is reduced to enable the hook portion to pass through the opening at the frame receiving receptacle.

19. The method of claim 14, wherein the hook portion comprises a first hook portion and a second hook portion, the first hook portion extending out radially from the vertical lower section along a first axis, the second hook portion extending out radially from the first hook portion along a second axis that is offset from the first axis.

20. The method of claim 14, wherein, when the hook portion is at the biased, coupling configuration and received within the frame receiving receptacle, the solar module frame is coupled to the rail without a fastening component at the hook portion.
